(19) United States
(12) Patent Application Publication
(10) Pub. No.: US 2006/0104442 A1
(43) Pub. Date: May 18, 2006

(54) Method and apparatus for receiving broadcast content

(75) Inventors: Sung-hyu Han, Seoul (KR); Myung-sun Kim, Uiwang-si (KR); Yong-kuk You, Seoul (KR); Young-sun Yoon, Suwon-si (KR); Bong-seon Kim, Seongnam-si (KR); Jae-heung Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/242,076

(22) Filed: Oct. 4, 2005

Related U.S. Application Data
(60) Provisional application No. 60/627,967, filed on Nov. 16, 2004.

(30) Foreign Application Priority Data
Nov. 26, 2004 (KR) 10-2004-0097998

(51) Int. Cl. H04L 9/00

(52) U.S. Cl. 380/44

(57) ABSTRACT

An apparatus for receiving broadcast content is provided. The apparatus includes a receiving unit generating the broadcast content from a broadcast stream received from a content provider via a broadcast channel; a content encrypting unit encrypting the broadcast content using a content key; and a link generating unit generating a secure link to a user device by exchanging link messages with the user device, and transmitting the content key to the user device via one of the link messages even when the apparatus is not connected to a content provider. A first link message of the link messages includes one of a public key of the user device and a public key of the apparatus, and a second link message of the link messages includes one of a private key of the apparatus, a secret key of the apparatus, and a secret key of the user device.

### CROSS-REFERENCE TO RELATED PATENT APPLICATIONS

This application claims the priorities of U.S. Provisional Application No. 60/627,967, filed on Nov. 16, 2004 in the U.S. Patent and Trademark Office, and Korean Patent Application No. 10-2004-0097998, filed on Nov. 26, 2004 in the Korean Intellectual Property Office, the disclosures of which are incorporated herein in their entirety by reference.

### BACKGROUND OF THE INVENTION

1. Field of the Invention

Apparatuses and methods consistent with the present invention relate to receiving broadcast content, and more particularly, to securely transmitting broadcast content to a user device even in an offline mode in which the user device is not connected to a content provider.

2. Description of the Related Art

Digital content is transmitted from a content provider to a user. The digital content must be protected such that only an authorized user who pays for the digital content and obtains a right therefor can use the digital content.

To prevent an unauthorized use of the digital content, the digital content is encrypted using a content key and the content key is given to only authorized users.

Recent advancement in home network technology enables a user to own two or more user devices and content to be exchanged between two or more user devices. Thus, the user is likely to desire to use content in all their devices by paying for the content only once. However, when exchange of the content between devices is allowed, it is highly probable that an unauthorized user would obtain and use the content. For this reason, it is necessary to develop home network technology that permits exchange of content between an authorized user's devices but does not permit an unauthorized user to obtain or use the content.

FIG. 1 is a diagram illustrating a conventional method of receiving content via the Internet 10. Referring to FIG. 1, a content provider CP transmits the content to user devices D1, D2, and D3 via the Internet 10. Since the user devices D1 through D3 are connected to the content provider CP via the Internet 10, bi-directional communications can be made between the content provider CP and each of the user devices D1 through D3.

Accordingly, the content provider CP can protect the content from unauthorized users through user authentication that determines whether the user devices D1 through D3 are authorized devices, and by encrypting and transmitting the content and a content key.

If the user devices D1 through D3 are over a home network HN of a user, the user can use the content in the user devices D1 through D3, free from attacks of unauthorized users.

FIG. 2 is a diagram illustrating a conventional method of receiving content via a broadcast channel 20. Referring to FIG. 2, a content provider CP transmits the content to user devices D1, D2, and D3 via the broadcast channel 20. The content is received via a digital broadcast receiver 12 which is referred to as a set-top box (STB), and transmitted to the user devices D1 through D3.

Since the content provider CP unilaterally transmits the content to the user devices D1 through D3 via a broadcast signal, bi-directional communications cannot be made between the content provider CP and each of the user devices D1 through D3.

In this case, the content provider CP cannot protect the content from unauthorized users through user authentication that determines whether the user devices D1 through D3 are authorized devices, and by encrypting and transmitting the content and a content key.

Accordingly, content protection such as the user authentication is not applicable to a scenario that digital broadcast content is received via a broadcast channel, i.e., a set-top box. Specifically, in general, the set-top box has only functions of receiving digital broadcast content according to a predetermined broadcast protocol and transmitting the received digital broadcast content to the user devices D1 through D3 over a home network HN of a user. Therefore, when digital broadcast content is received using the set-top box, it is impossible to prevent an unauthorized user from obtaining the content.

The Federal Communications Commission (FCC) has prescribed a standard for digital broadcast technology that a 1-bit broadcast flag must be included in high-definition (HD) content to be broadcast through U.S. digital broadcast systems and content protection must be activated to prevent an unauthorized user from using the content when the broadcast flag is 1, as of July 2005. Thus, it is urgent to develop a method and apparatus for securely obtaining and using digital broadcast content even in an offline mode in which a user device is not connected to a content provider via the Internet, and thus, bi-directional communications cannot be made between the content provider and the user device.

### SUMMARY OF THE INVENTION

The present invention provides a broadcast content receiving apparatus and method capable of allowing content to be reproduced in only an authorized user device even when bi-directional communications cannot be made between a content provider and the authorized user device.

According to an aspect of the present invention, there is provided an apparatus for receiving broadcast content, the apparatus comprising a receiving unit which generates the broadcast content from a broadcast stream received from a content provider via a broadcast channel; a content encrypting unit which encrypts the broadcast content using a content key; and a link generating unit which generates a secure link to a user device by exchanging link messages with the user device, the link generating unit transmitting the content key to the user device, via one of the link messages even when the apparatus is not connected to a content provider. A first link message of the link messages comprises one of a public key of the user device and a public key of the apparatus, and a second link message of the link messages comprises one of a private key of the apparatus, a secret key of the apparatus and a secret key of the user device.

The link generating unit counts a number of link request messages transmitted from the user device, compares a number of current links with a maximum number of available links, and controls the number of current links.

The link generating unit may transmit the content key to the user device by encrypting the private key of the apparatus using the public key of the user device, transmitting the encrypted private key to the user device via the second link message, encrypting the content key using the public key of the apparatus, and transmitting the encrypted content key to the user device.

The link generating unit may transmit the content key to the user device by encrypting the secret key of the apparatus using the public key of the user device, transmitting the encrypted secret key to the user device via the second link message, encrypting the content key using the secret key of the apparatus, and transmitting the encrypted content key to the user device.

The link generating unit may transmit the content key to the user device by receiving the secret key of the user device via the second link message, which is encrypted using the public key of the apparatus, encrypting the content key using the secret key of the user device, and transmitting the encrypted content key to the user device.

According to another aspect of the present invention, there is provided a method of receiving broadcast content, the method comprising generating content from a broadcast stream received from a content provider via a broadcast channel; encrypting the content using a content key; and generating a secure link between a user device and a broadcast content receiving apparatus by exchanging link messages between the user device and the broadcast content receiving apparatus, and transmitting the content key to the user device via one of the link messages through the secure link when the broadcast content receiving apparatus is not connected to the content provider. A first link message of the link messages comprises one of a public key of the user device and a public key of the broadcast content receiving apparatus, and a second link message of the link messages comprises one of a private key of the broadcast content receiving apparatus, a secret key of the broadcast content receiving apparatus, and a secret key of the user device.

According to another aspect of the present invention, there is provided a computer readable recording medium for storing a program which executes the method of receiving broadcast content.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a conventional method of receiving content via the Internet;

FIG. 2 is a diagram illustrating a conventional method of receiving content via a broadcast channel;

FIG. 3 is a block diagram of an apparatus for receiving broadcast content according to an exemplary embodiment of the present invention;

FIG. 4 is a block diagram of a user device according to an exemplary embodiment of the present invention;

FIG. 5 is a flowchart of a method of generating a link using a link generating unit according to an exemplary embodiment of the present invention;

FIG. 6 is a flowchart of a method of generating a link using a link generating unit according to another exemplary embodiment of the present invention;

FIG. 7 is a flowchart of a method of generating a link using a link generating unit according to yet another exemplary embodiment of the present invention; and

FIG. 8 is a flowchart of a method of receiving broadcast content according to an exemplary embodiment of the present invention.

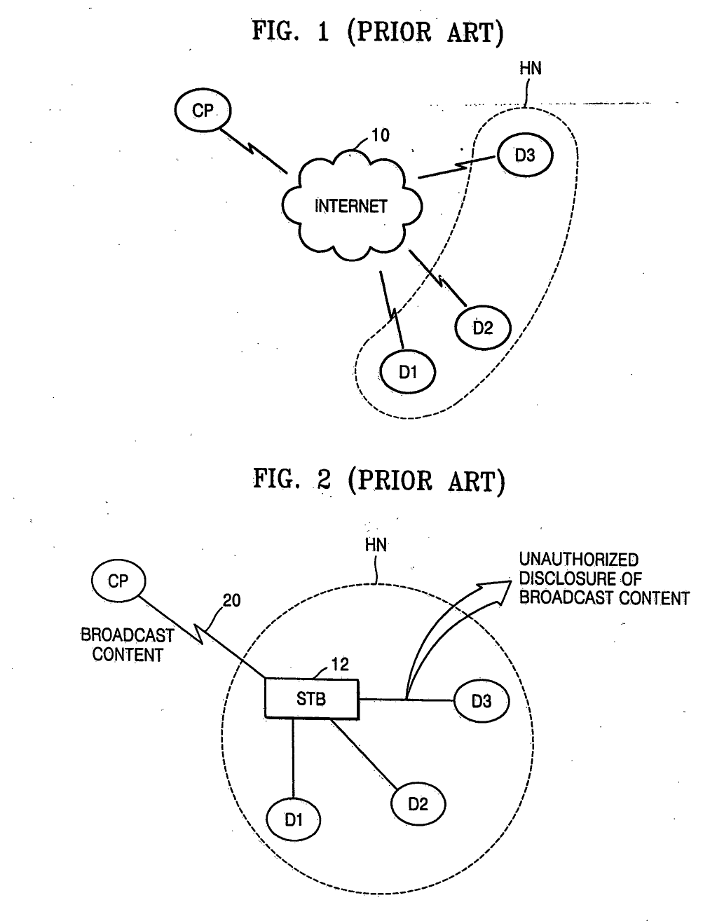

### DETAILED DESCRIPTION OF EXEMPLARY EMBODIMENTS OF THE INVENTION

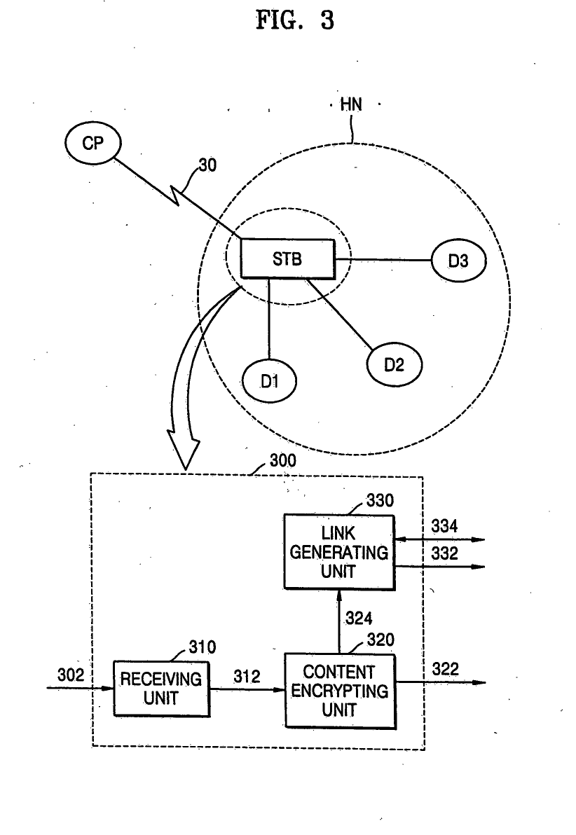

FIG. 3 is a block diagram of an apparatus 300 for receiving broadcast content according to an exemplary embodiment of the present invention. The apparatus 300, which corresponds to a digital broadcast receiver STB, includes a receiving unit 310, a content encrypting unit 320, and a link generating unit 330.

The receiving unit 310 receives a broadcast stream 302 via a broadcast channel 30, and generates content 312 by extracting packets corresponding to a user's desired content from the broadcast stream 302 and combining the extracted packets.

The content encrypting unit 320 obtains encrypted content 322 by encrypting the content 312 using a predetermined content key 324. The content key 324 may be generated by the content encrypting unit 320, or be externally generated and provided to the content encrypting unit 320. In any case, the content key 324 must be obtainable only by authorized users. When using the content encrypting unit 320, the content key 324 may be obtained by generating random numbers. The content key 324 is securely transmitted to a user device D1, D2, or D3 through the link generating unit 330.

The link generating unit 330 generates a secure link to the user device D1, D2, or D3 by exchanging a link message 334 with the user device D1, D2, or D3, and sends an encrypted content key 332 to the user device D1, D2, or D3 using the secure link.

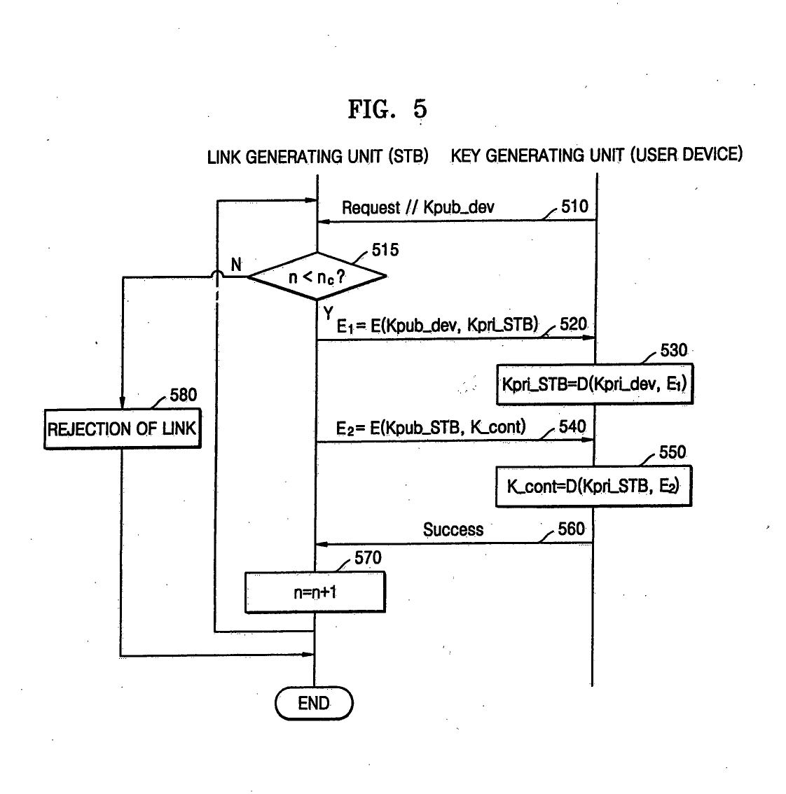

The secure link is a path along which the content key 324 is exchanged between the digital broadcast receiver STB and each of the user devices D1 through D3. Devices, other than the digital broadcast receiver STB and the user devices D1 through D3, are not allowed to obtain the content key 324 through the secure link. Exchange of the link message 334 between the link generating unit 330 and each of the user devices D1 through D3 will later be described in detail with reference to FIGS. 5 through 7.

Alternatively, the link generating unit 330 may count the number of current links and limit the number of user devices to be connected to the digital broadcast receiver STB according to the number of current links.

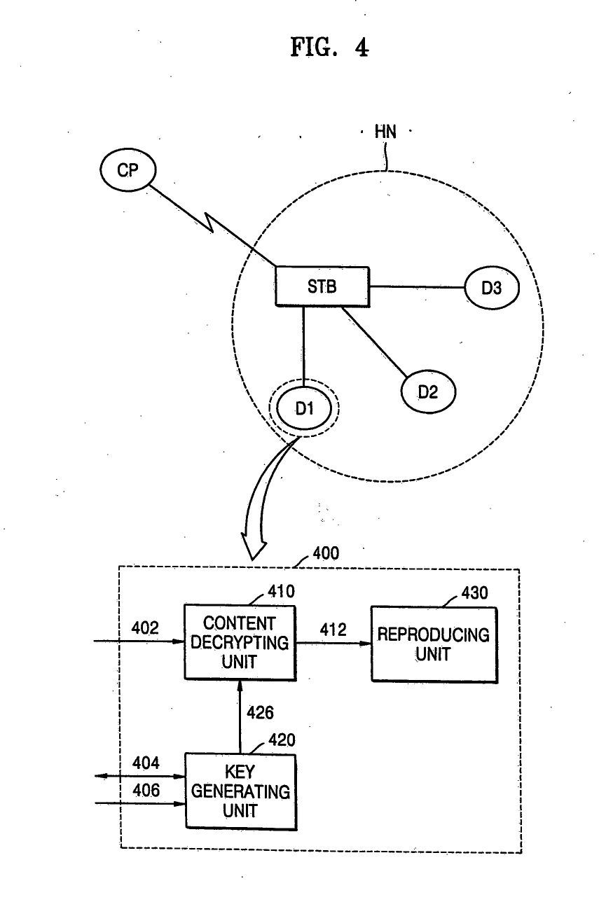

FIG. 4 is a block diagram of a user device 400 according to an exemplary embodiment of the present invention. The user device 400, which corresponds to the user device D1, D2, or D3, receives broadcast content from a digital broadcast receiver STB and reproduces the broadcast content. The user device 400 includes a content decrypting unit 410, a key generating unit 420, and a reproducing unit 430.

The content decrypting unit 410 receives encrypted content from the digital broadcast receiver STB, e.g., the content encrypting unit 320 of the apparatus 300 of FIG. 3, and obtains decrypted content 412 by decrypting the encrypted content 402 using a content key 426. The content key 426 is generated by the key generating unit 420.

The key generating unit 420 receives an encrypted content key 332 from the digital broadcast receiver STB, e.g., the link generating unit 330 of the apparatus 300, by exchanging a link message 404 with the digital broadcast receiver STB. Exchange of the link message 404 between the user device 400 and the link generating unit 330 will later be described in detail with reference to FIGS. 5 through 7.

A method of generating a link by exchanging link messages between a link generating unit and a digital broadcast receiver, and transmitting a content key to a user device via the link, according to the present invention, will now be described with reference to FIGS. 5 through 7.

FIG. 5 is a flowchart of a method of generating a link using the link generating unit 330 of FIG. 3 according to an exemplary embodiment of the present invention. Referring to FIG. 5, the link generating unit 330 receives a link message Request that requests a link of the user device 400 of FIG. 4 to the apparatus 300 of FIG. 3, and a public key Kpub_dev of the user device 400 of FIG. 4 from the key generating unit 420 (operation 510).

Next, the link generating unit 330 determines whether the maximum number of available links n_{c} is greater than the number of current links n (operation 515). If the maximum number of available links n_{c} is greater than the number of current links n, the method proceeds to operation 520. If not, a link message that rejects the link of the user device 400 to the apparatus 300 is transmitted to the user device 400 to reject the link of the user device 400 (operation 580).

In operation 520, the link generating unit 330 generates an encrypted private key E1=E(Kpub_dev, Kpri_STB) by encrypting a private key Kpri_STB of the apparatus 300 using the public key Kpub_dev received in operation 510, and transmits the encrypted private key E1 to the key generating unit 420.

Next, the key generating unit 420 reproduces the private key Kpri_STB of the apparatus 300 by decrypting the encrypted private key E1, which is received in operation 520, using a private key Kpri_dev of the user device 400 (operation 530).

Next, the link generating unit 330 generates an encrypted content key E2=E(Kpub_STB, K_cont) by encrypting a content key K_cont using the public key Kpub_STB of the apparatus 300, and transmits the encrypted content key E2 to the key generating unit 420 (operation 540).

Next, the key generating unit 420 reproduces the content key K_cont by decrypting the encrypted content key E2 using the private key Kpri_STB of the apparatus 300 reproduced in operation 530 (operation 550).

Next, the key generating unit 420 transmits a link message Success that the content key K_cont is successfully reproduced to the link generating unit 330 (operation 560).

Thereafter, the link generating unit 330 increases the number of the current links n by one (operation 570), and the method proceeds to operation 510.

In the method of FIG. 5, a content key is securely transmitted from a broadcast content receiving apparatus 300 to a user device 400 according to a public key infrastructure (PKI). That is, the content key is securely transmitted to the user device 400, using private keys and public keys of a user device 400 and a broadcast content receiving apparatus 300. Even if a link message transmitted in operation 510, 520, or 540 is hacked by an external device, all the link messages are encrypted, and thus, the external device cannot reproduce a content key. Accordingly, the broadcast content receiving apparatus 300 can transmit the content key to the user device 400 via a secure link.

Further, in the method of FIG. 5, the broadcast content receiving apparatus 300 can securely transmit content to the user device 400 in an offline mode in which the user device 400 is not connected to a content provider CP, and therefore, satisfy the standard for digital broadcast technology that HD content must include a broadcast flag and content protection must be activated to prevent an unauthorized user from using the content when the broadcast flag is 1, as prescribed by the FCC.

In the method of FIG. 5, operations 515, 560, 570, and 580 are optional. Inclusion of operations 515, 560, 570, and 580 makes it possible to limit the number of user devices in which content is reproduced, thereby preventing the content from being illegally spread.

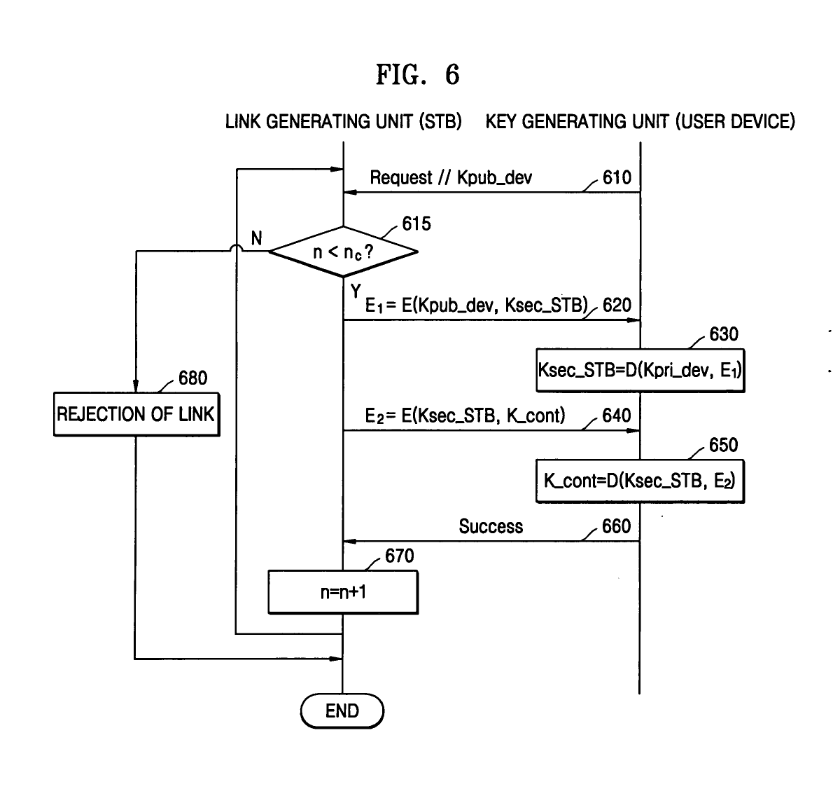

FIG. 6 is a flowchart of a method of generating a link using the link generating unit 330 of the apparatus 300 of FIG. 3 according to another exemplary embodiment of the present invention. Referring to FIG. 6, the link generating unit 330 receives a link message Request that requests a link of the user device 400 to the apparatus 300 and a public key Kpub_dev of the user device 400 from the key generating unit 420 of the user device 400 of FIG. 4 (operation 610).

Next, the link generating unit 330 determines whether the maximum number of available links n_{c} is greater than the number of current links n (operation 615). If the maximum number of available links n_{c} is greater than the number of current links n, the method proceeds to operation 620. If not, a link message that rejects the link of the user device 400 to the apparatus 300 is sent to the user device 400 to reject the link of the user device 400 (operation 680).

In operation 620, the link generating unit 330 generates an encrypted secret key E1=E(Kpub_dev, Ksec_STB) by encrypting a secret key Ksec_STB of the apparatus 300 using the public key Kpub_dev of the user device 400 received in operation 610, and transmits the encrypted secret key E1 to the key generating unit 420.

Next, the key generating unit 420 reproduces the secret key Ksec_STB of the apparatus 300 by decrypting the encrypted secret key E1 received in operation 620 using a private key Kpri_dev of the user device 400 (operation 630).

Next, the link generating unit 330 generates an encrypted content key E2=E(Ksec_STB, K_cont) by encrypting a content key K_cont using the secret key Ksec_STB, and transmits the encrypted content key E2 to the key generating unit 420 (operation 640).

Next, the key generating unit 420 reproduces the content key K_cont by decrypting the encrypted content key E2 using the secret key Ksec_STB generated in operation 630 (operation 650).

Next, the key generating unit 420 transmits a message Success that the content key K_cont is successfully reproduced to the link generating unit 330 (operation 660).

Thereafter, the link generating unit 330 increases the number of current links n by one (operation 670), and then, the method proceeds to operation 610.

In the method of FIG. 6, a content key is securely transmitted, using a private key and a public key of a user device 400, and a secret key of a broadcast content receiving apparatus 300. The method of FIG. 6 is different from the method of FIG. 5 in that the content key is transmitted from a broadcast content receiving apparatus 300 to a user device 400 according to a symmetrical key structure. However, as in the method of FIG. 5, all link messages exchanged in operations 610, 620, and 640 of the method of FIG. 6 are encrypted and transmitted. Thus, an unauthorized user cannot reproduce the content key, and thus, it is possible to securely transmit the content key from the broadcast content receiving apparatus 300 to the user device 400 via a secure link.

Similarly, operations 615, 660, 670 and 680 are optional.

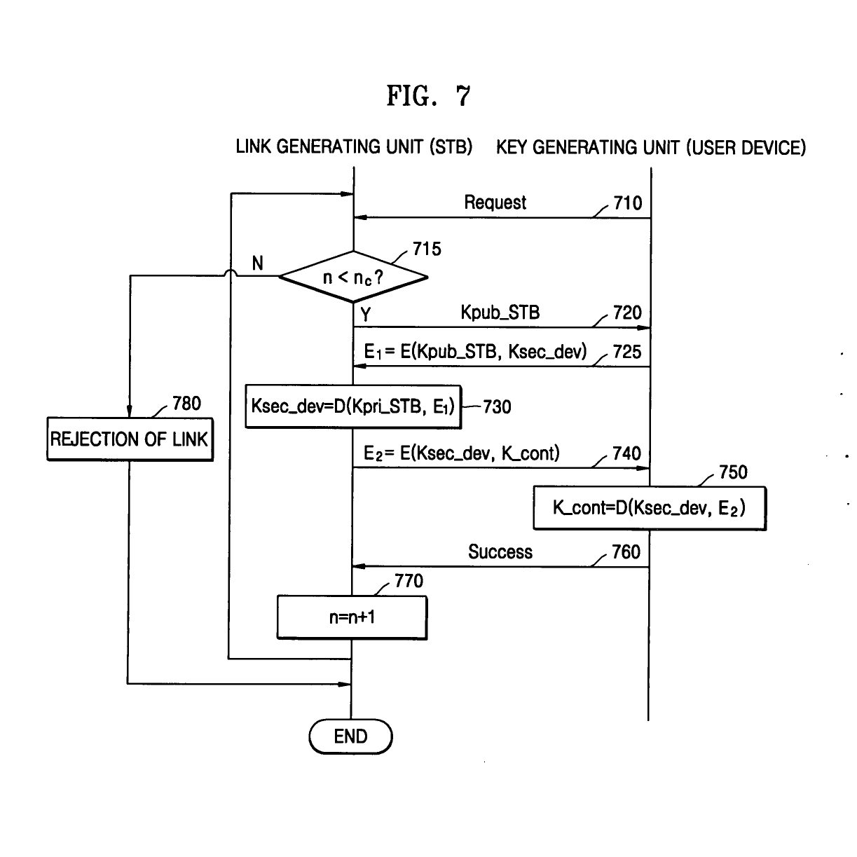

FIG. 7 is a flowchart of a method of generating a link according to yet another exemplary embodiment of the present invention. Referring to FIG. 7, the link generating unit 330 of the apparatus 300 of FIG. 3 receives, from the key generating unit 420, a link message Request that requests a link of the user device 400 of FIG. 4 to the apparatus 300 (operation 710).

Next, the link generating unit 330 determines whether the maximum number of available links n_{c} is greater than the number of current links n (operation 715). If the maximum number of available links n_{c} is greater than the number of current links n, the method proceeds to operation 720. If not, a message that requests a link of the user device 400 to the apparatus 300 is transmitted to the user device 400 to reject the link of the user device 400 (operation 780).

In operation 720, the link generating unit 330 transmits a public key Kpub_STB of the apparatus 300 to the key generating unit 420 of the user device 400.

Next, the key generating unit 420 generates an encrypted secret key E1=E(Kpub_STB, Ksec_dev) by encrypting a secret key Ksec_dev of the user device 400 using the public key Kpub_STB of the apparatus 300 received in operation 720, and transmits the encrypted secret key E1 to the link generating unit 330 (operation 725).

Next, the link generating unit 330 reproduces the secret key Ksec_dev of the user device 400 by decrypting the encrypted secret key E1 of the user device 400 received in operation 725 using the private key Kpri_STB of the apparatus 300 (operation 730).

Next, the link generating unit 330 generates an encrypted content key E2=E(Ksec_dev, K_cont) by encrypting a content key K_cont using the secret key Ksec_dev of the user device 400 generated in operation 730, and transmits the encrypted content key E2 to the key generating unit 420 (operation 740).

Next, the key generating unit 420 reproduces the content key K_cont by decrypting the encrypted content key E2 received in operation 740 using the secret key Ksec_dev of the user device 400 (operation 750).

Next, the key generating unit 420 transmits a message Success that the content key K_cont is successfully reproduced to the link generating unit 330 (operation 760).

Next, the link generating unit 330 increases the number of current links n (operation 770), and the method proceeds to operation 710.

In the method of FIG. 7, a content key is encrypted using a secret key of a user device 400. The secret key is a unique key that is allocated to a user device 400 and is not disclosed to external devices. As in the methods of FIGS. 5 and 6, even when link messages transmitted in operations 710, 720, 725, and 740 are hacked by an external device, all the link messages are encrypted and thus do not allow the external device to reproduce the content key. Accordingly, a broadcast content receiving apparatus 300 is capable of securely transmitting the content key to the user device 400 via a secure link.

Similarly in the methods of FIGS. 5 and 6, operations 715, 760, 770 and 780 are optional.

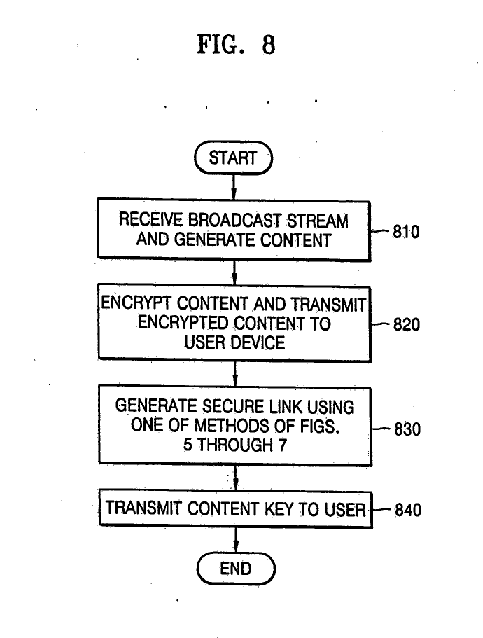

FIG. 8 is a flowchart of a method of receiving broadcast content according to an exemplary embodiment of the present invention. Referring to FIG. 8, an apparatus for receiving broadcast content receives a broadcast stream via a broadcast channel, and reproduces the broadcast content from the broadcast stream (operation 810).

Next, the apparatus encrypts the broadcast content reproduced in operation 810 using a predetermined content key, and transmits it to a user device 400 (operation 820).

Next, the apparatus generates a secure link by exchanging link messages with the user device (operation 830). A method of generating a secure link has been described with reference to FIGS. 5 through 7.

Next, the apparatus transmits the predetermined content key to the user device via the secure link generated in operation 830 (operation 840).

As described above, according to the present invention, it is possible to generate a secure link between a broadcast content receiving apparatus and a user device, and securely transmit broadcast content to the user device via the secure link even when the user device is not connected to a content provider.

Also, it is possible to limit the number of user devices that can be linked to an apparatus to receive broadcast content, thereby controlling use of the broadcast content.

An apparatus for receiving broadcast content can satisfy the standard for HD content that the HD content must include a broadcast flag as of July 2005, as prescribed by the FCC.

A method of receiving broadcast content according to the present invention may be embodied as a computer program. Code and code segments of the computer program may be easily derived by computer programmers skilled in the art to which the present invention pertains. The computer program may be stored in a computer-readable medium, and executed using a computer. Examples of the computer-readable medium include a magnetic recording medium, an optical recording medium, or even carrier waves (such as in transmission over the Internet).

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An apparatus for receiving broadcast content, the apparatus comprising:
a receiving unit which generates the broadcast content from a broadcast stream received from a content provider via a broadcast channel;
a content encrypting unit which generates the broadcast content using a content key; and
a link generating unit which generates a secure link to a user device by exchanging link messages with the user device, the link generating unit transmitting the content key to the user device via one of the link messages even when the apparatus is not connected to a content provider,
wherein a first link message of the link messages comprises one of a public key of the user device and a public key of the apparatus, and a second link message of the link messages comprises one of a private key of the apparatus, a secret key of the apparatus, and a secret key of the user device.

2. The apparatus of claim 1, wherein the link generating unit counts a number of link request messages transmitted from the user device, compares a number of current links with a maximum number of available links, and controls the number of current links.

3. The apparatus of claim 1, wherein the link generating unit transmits the content key to the user device by encrypting the private key of the apparatus using the public key of the user device, transmitting the encrypted private key to the user device via the second link message, encrypting the content key using the public key of the apparatus, and transmitting the encrypted content key to the user device.

4. The apparatus of claim 1, wherein the link generating unit transmits the content key to the user device by encrypting the secret key of the apparatus using the public key of the user device, transmitting the encrypted secret key to the user device via the second link message, encrypting the content key using the secret key of the apparatus, and transmitting the encrypted content key to the user device.

5. The apparatus of claim 1, wherein the link generating unit transmits the content key to the user device by receiving the secret key of the user device via the second link message, which is encrypted using the public key of the apparatus, encrypting the content key using the secret key of the user device, and transmitting the encrypted content key to the user device.

6. A method of receiving broadcast content, the method comprising:
generating content from a broadcast stream received from a content provider via a broadcast channel;
encrypting the content using a content key; and
generating a secure link between a user device and a broadcast content receiving apparatus by exchanging link messages between the user device and the broadcast content receiving apparatus, and transmitting the content key to the user device via one of the link messages through the secure link when the broadcast content receiving apparatus is not connected to the content provider,
wherein a first link message of the link messages comprises one of a public key of the user device and a public key of the broadcast content receiving apparatus, and a second link message of the link messages comprises one of a private key of the broadcast content receiving apparatus, a secret key of the broadcast content receiving apparatus, and a secret key of the user device.

7. The method of claim 6, wherein the generating the secure link comprises:
determining a number of current links by counting a number of link request messages transmitted from the user device; and
comparing the number of current links with a maximum number of available links, and controlling the number of current links.

8. The method of claim 6, wherein the generating the secure link comprises:
encrypting the private key of the apparatus using the public key of the user device, and transmitting the encrypted private key to the user device via the second link message; and
encrypting the content key using the public key of the apparatus, and transmitting the encrypted content key to the user device.

9. The method of claim 6, wherein the generating the secure link comprises:
encrypting the secret key of the apparatus using the public key of the user device, and transmitting the encrypted secret key to the user device via the second link message; and
encrypting the content key using the secret key of the apparatus, and transmitting the encrypted content key to the user device.

10. The method of claim 6, wherein the generating the secure link comprises:
receiving via the second link message the secret key of the user device which is encrypted using the public key of the apparatus;
encrypting the content key using the secret key of the user device; and
transmitting the encrypted content key to the user device.

11. A computer readable recording medium for storing a program which executes a method of receiving broadcast content, the method comprising:
generating content from a broadcast stream received from a content provider via a broadcast channel;
encrypting the content using a content key; and
generating a secure link between a user device and a broadcast content receiving apparatus by exchanging link messages between the user device and the broadcast content receiving apparatus, and transmitting the content key to the user device via one of the link messages through the secure link when the broadcast content receiving apparatus is not connected to the content provider,
wherein a first link message of the link messages comprises one of a public key of the user device and a public key of the broadcast content receiving apparatus, and one of a private key, a secret key of the broadcast content receiving apparatus and a secret key of the user device.
